(19) United States
(12) Patent Application Publication
(10) Pub. No.: US 2010/0081423 A1
(43) Pub. Date: Apr. 1, 2010

(54) Devices and Methods for Utilizing Multiple Accounts Through A Single Mobile Device

(75) Inventor: Marachel L. Knight, Plano, TX (US)

Correspondence Address: AT&T Legal Department - Moazzam;Attn: Patent Docketing, Room 2A-207, One AT&T Way, Bedminster, NJ, 07921, US

(73) Assignee: AT&T INTELLECTUAL PROPERTY II, L.P., Reno, NV (US)

(21) Appl. No.: 12/242,773

(22) Filed: Sep. 30, 2008

(51) Int. Cl. H04W 4/00; H04M 1/00; H04B 1/38

(52) U.S. Cl. 455/422.1; 455/575.1; 455/558

(57) ABSTRACT

Devices and methods are disclosed which relate to mobile devices on a cellular network. A multi-number mobile device is introduced which enables a user to use multiple connecting numbers or identifiers on a single mobile device. The multi-number mobile device contains a plurality of hardware IDs, each of which is registered on a service-provider's network. The multi-number mobile device is equipped with software that enables the user to choose among the hardware IDs and set default preferences concerning which hardware ID to use depending on the service or situation.

### BACKGROUND OF THE INVENTION

1. Field of the Invention

The present invention relates to the utilization of multiple wireless accounts on a single mobile device. Moreover, the present invention relates to a cellular telephone that contains multiple hardware IDs.

2. Background of the Invention

Cellular telephones are tremendously popular. It is estimated that at the end of 2007 the total worldwide subscriber rate reached 3.3 billion. Close to 80% of the world's population enjoys mobile telephone coverage, a figure that will only increase. As cellular telephones gain popularity, their functionality has increased also. Standard service includes voice calling, caller ID, call waiting, and voice mail. Service providers also offer text messaging, push mail, navigation, and even a high-speed internet connection directly to the telephone.

At the same time, people have become much more dependent on their cellular telephones. Many people no longer have traditional land-line telephones in their house, instead choosing to rely on their cellular telephone. Cellular telephones can accomplish almost everything that a land-line telephone does with the added benefit of mobility. And that is the least a cellular telephone has to offer.

In the business world cellular telephones have become a necessity. With the fast pace of business today, people must be reachable at any time of day, every day. With cellular telephones, laptop computers, and Personal Digital Assistants (PDAs), users can easily be called or e-mailed anytime and almost anywhere. Companies have come to rely on the luxury of instant communication with their employees. Decisions can be made faster and more confidently. For the small business entrepreneur, hiring employees is not always a priority, especially in the beginning. These entrepreneurs must handle everything themselves at times, and need to stay connected to their clients. Having telephone calls, email, internet, and navigation all on one mobile device is invaluable.

Growing number of companies will give their employees cellular telephones, laptop computers, PDAs and other electronics for business use. Since many of their employees already have a personal cellular telephone, many of these employees encounter a dilemma. Concerned with the hassle of changing their personal number, many forego the possibility of making the business telephone their personal telephone as well. Also, businesses often frown upon personal calls being made from company devices. Thus, because of the necessity of a cellular telephone for both business and pleasure, many people are forced to have multiple accounts, meaning they must carry around more than one telephone.

Small business entrepreneurs find it hard to separate their personal and business lives. Maintaining contact with clients must be a priority, but this can lead to a mixture of business and leisure. E-mailing a client back while in the middle of the supermarket can become a common occurrence. The desire to have a personal telephone and a business telephone comes into view quickly, but the present solutions are far from ideal.

There are a few ways to cope with the problem of having to carry multiple cellular telephones. As technology improves mobile devices get smaller and lighter. However, the burden is not limited to sheer size and weight. Additionally, there's the burden of making sure two batteries are charged, which means making sure to pack two AC adapters when traveling. Different telephones will most likely require different types of memory cards. Any games, ring tones, or music downloaded will be limited to that telephone.

In order for the service provider to differentiate between cellular telephones, it must read the hardware ID from the telephone. Each cellular telephone has a unique hardware ID stored within the telephone itself. Some cellular telephones have a hardware ID along with the user's name and account information. This information is stored on an identifier, also within the cellular telephone. The identifier, in some cases, contains its own memory and processor, and is removable.

Global System for Mobile communications (GSM) and other devices utilize identifiers called SIM cards. SIM cards securely store the service-subscriber key (IMSI) used to identify a subscriber. The SIM card currently allows users to change telephones by simply removing the SIM card from one mobile telephone and inserting it into another mobile telephone or broadband telephony device. However, each SIM card only utilizes one account and telephone number.

Some cellular telephones do not have a SIM card, such as devices using a Code Division Multiple Access (CDMA) protocol. These cellular telephones have simply a hardware ID that is read by the service provider and assigned an account on the server side, but the hardware ID is not removable. Furthermore many of these telephones do not accept SIM cards. For people having multiple telephones, at least one of which does not utilize a SIM card, the need for a personal and business telephone requires them to carry two separate fully functional cellular telephones or other electronic devices.

There are few advantages to land-line telephones in this day, but businesses have been using one telephone for a plurality of different lines for years now. What is needed is a cellular telephone and electronic system that can utilize two or more separate numbers and plans without using multiple SIM cards.

### SUMMARY OF THE INVENTION

The present invention includes a mobile device possessing multiple hardware IDs and capable of utilizing each one separately while allowing a network to identify the mobile device by any of them. A user can utilize multiple accounts on a single mobile device and switch among them. The user may select which account to place any call from, while retaining the ability to receive calls made to any account. Software on the mobile device gives the user the option of selecting an account or creating a default account.

Furthermore, the multi-number mobile device is programmed with software to help use multiple accounts more effectively. This software allows the user to set a plurality of preferences, including a default account, call waiting preferences, and contact-specific preferences. For example, the user can have all calls to the personal account sent directly to voicemail while the user is using the business account. The mobile device's software allows it to connect to a service provider's network and utilize all the accounts without the service provider ever knowing that each hardware ID is on the same mobile device.

In one exemplary embodiment, the present invention is a multi-number mobile device comprising a housing, a memory within the housing, a processor within the housing, an identifier within the housing, a plurality of hardware IDs within the identifier, and a wireless transmitter coupled to the housing. The identifier switches among the plurality of hardware IDs without the need for multiple identifiers.

In another exemplary embodiment, the present invention is a multi-number mobile device comprising a housing, a memory within the housing, a processor in communication with the memory, a plurality of hardware IDs within the memory; and an antenna coupled to the housing. The processor switches among the plurality of hardware IDs.

In yet another exemplary embodiment, the present invention is a method of connecting a mobile device through a cellular connection comprising providing a mobile device possessing multiple hardware IDs and capable of utilizing each one separately while allowing a network to identify the mobile device by any of them, and connecting the mobile device through the network. The mobile device registers each hardware ID with the network independently and simultaneously.

### BRIEF DESCRIPTION OF THE DRAWINGS

FIG. 1 shows a multi-number cellular telephone, according to an exemplary embodiment of the present invention.

FIG. 2 shows a SIM card used by a multi-number telephone, according to an exemplary embodiment of the present invention.

FIG. 3 shows a screenshot of a menu system of a multi-number device, according to an exemplary embodiment of the present invention.

FIG. 4 shows a multi-number telephone in communication with a system, according to an exemplary embodiment of the present invention.

FIG. 5 shows a flowchart of a multi-number device beginning with an incoming call, according to an exemplary embodiment of the present invention.

### DETAILED DESCRIPTION OF THE INVENTION

The present invention includes a mobile device possessing multiple hardware IDs and capable of utilizing each one separately while allowing a network to identify the mobile device by any of them. A user can utilize multiple accounts on a single mobile device and switch among them. The user may select which account to place any call from, while retaining the ability to receive calls made to any account. Software on the mobile device gives the user the option of selecting an account or creating a default account.

“Mobile device”, as used herein and throughout this disclosure, refers to a portable device capable of wireless communication, and of the type that typically registers on the network of a service provider upon use. Examples of mobile devices include, but are not limited to, cellular telephones, wireless broadband aircards, etc. Other types not specifically disclosed herein but as would be appreciated by one of ordinary skill in the art and be functional with the present invention are also within the scope of the present disclosure and claims.

“Identifier”, as used in this disclosure, refers to a mechanism within a cellular telephone that contains a hardware ID of the cellular telephone. An example of an identifier is a SIM card. Identifiers can store more information than simply a hardware ID, and may have their own processors and memory.

“Hardware ID”, as used in this disclosure, refers to the unique code within a mobile device that identifies it from every other mobile device on a network. Examples of a hardware ID include a service-subscriber key, an Electronic Serial Number (ESN), a Media Access Control (MAC) address, a serial number, etc. The hardware ID is usually an alphanumeric code. A device can have a single ESN, MAC, serial number, etc., and be considered a single hardware ID. When reference is made to multiple or a plurality of hardware IDs, this refers to more than one ESN, more than one MAC address, more than one serial number, etc.

“Network Registration”, as used in this disclosure, refers to the process initiated by a mobile device powering on or entering the range of a cellular tower. This process includes identification and authentication such that the mobile device is allowed communication with the network.

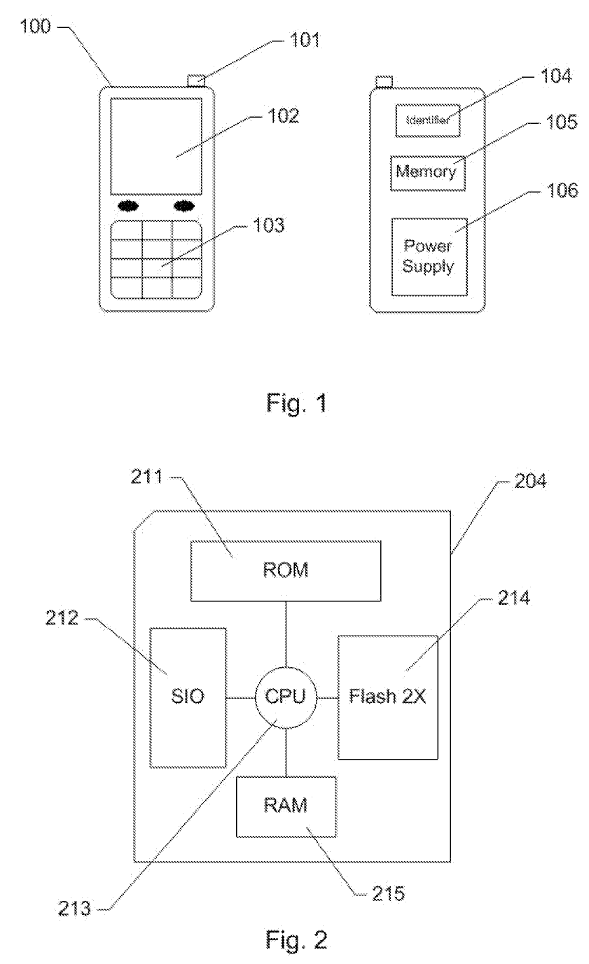

FIG. 1 shows a mobile device in the form of a personal data assistant or multi-number cellular telephone, according to an exemplary embodiment of the present invention. In this embodiment, cellular telephone 100 includes a power supply 106, a memory unit 105, an identifier 104, an antenna 101, a screen 102, and a keypad 103. Power supply 106 provides power to telephone 100 and all of its features. Memory 105 is the telephone internal memory. Memory 105 stores telephone 100's operating system, programs, multimedia, and available functions, which allow telephone 100 to operate. In embodiments of the invention, memory 105 also stores photos taken, text messages received and sent, ringtones, telephone numbers, etc. Memory 105 also communicates with identifier 104. Identifier 104 stores a hardware ID such as a service-subscriber key which is used to identify the subscriber. Identifier 104 may also store an authentication key, a local area identity, and an operator-specific emergency number. In embodiments of the present invention, identifier 104 may also store carrier specific data such as a short message service center number, a service provider name, service dialing numbers, advice-of-charge parameters, and value added service applications. In the present embodiment, identifier 104 stores multiple service-subscriber keys. This allows identifier 104 to carry more than one number, each associated with a different account. Antenna 101 allows signals to be transmitted and received from cellular towers, allowing telephone 100 to communicate with other telephones and devices. Keypad 103 and screen 102 act as input and output devices for telephone 100. Keypad 103 allows user to select options, make calls, compose text messages, etc. Screen 102 is the main output module for displaying everything from caller ID to internet browsing.

In various exemplary embodiments of the present invention, an identifier contains a plurality of hardware IDs. When the mobile device is first powered on, or when it encounters a new tower, the mobile device registers on the network of the service provider. For a multi-number mobile device, each hardware ID is registered on the network. The network may or may not know that each hardware ID exists within the same mobile device, and sends calls for any phone number associated with any of the hardware IDs to that mobile device. The identifier is capable of switching among the different hardware IDs when placing a call, while registering each hardware ID allows it to receive calls directed to any hardware ID. The identifier contains a processor and a memory of its own. The memory stores the hardware ID at a minimum. Other embodiments allow for other information to be stored on the memory of the identifier, such as a user name, phone number, and account information.

In one exemplary embodiment, shown in FIG. 2, the identifier is a SIM card modified to allow multi-number usage. FIG. 2 shows a SIM card 204 used by a multi-number device. In this embodiment, SIM card 204 comprises a central processing unit (CPU) 213, a serial input/output (SIO) 212, flash memory 214, random access memory (RAM) 215, and read-only memory (ROM) 211. A multi-number mobile device communicates with SIM card 204 through the SIO 212, which is a series of electrical contacts located on the surface of SIM card 204. In order to register on a network, a multi-number mobile device requests a hardware ID from SIM card 204. This request is processed by CPU 213, which then reads each hardware ID stored in flash memory 214. Each hardware ID is sent back through SIO 212 to the mobile device. The mobile device then registers each hardware ID on the network separately. The network can be oblivious to the fact that the newly registered hardware IDs belong to the same mobile device, or it can be a multi-number network, as described in co-pending application Ser. No. ______, filed Sep. 30, 2008, which is hereby incorporated by reference herein in its entirety.

In certain exemplary embodiments, the multi-number mobile device is a mobile telephone. When a call is placed to a telephone number associated with a hardware ID onboard a mobile telephone, the network simply routes the call toward the mobile telephone. However, when placing an outgoing call from the mobile telephone, an immediate decision needs to be made; which hardware ID, and thus which telephone number and account will be used to place this call? A multi-number mobile telephone is equipped with an operating system capable of handling this event. The operating system, in addition to providing the core capabilities of any mobile telephone, includes programs that allow the user to select which hardware ID, account, and phone number to use for any call.

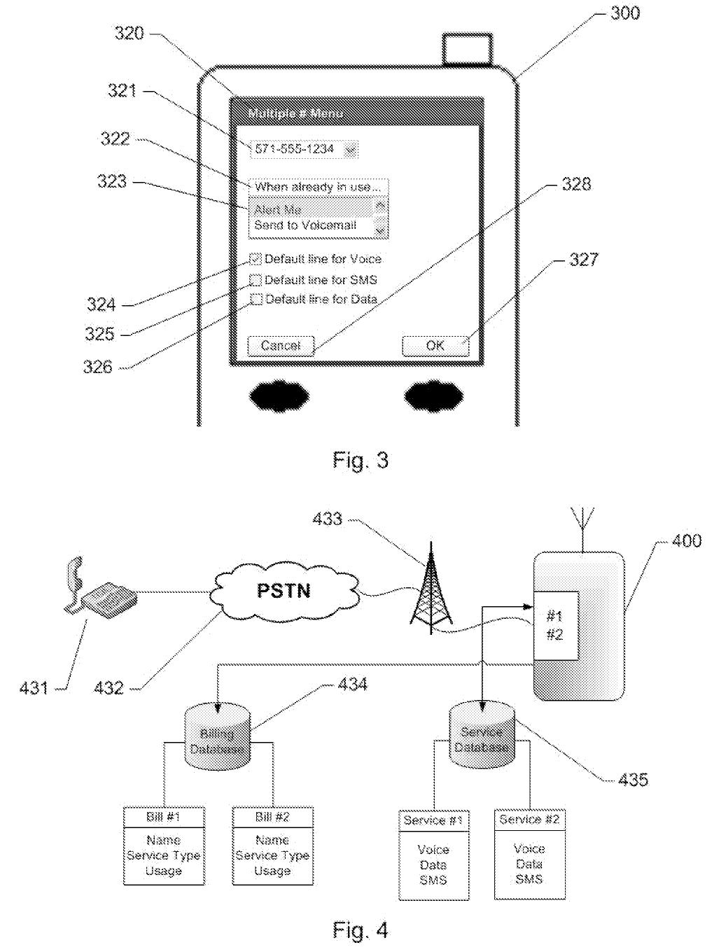

FIG. 3 shows a screenshot of a menu system 320 of a multi-number device, according to an exemplary embodiment of the present invention. In this embodiment, the user selects his preferences for each telephone number on a multi-number mobile device 300. The user begins by selecting a telephone number 321 for which to create preferences. The user may then select call interruption preferences 322, such as for a call waiting service. In this example, the user is selecting his preferences for when the telephone number dialed is in use. The user has selected to be alerted 323, such as with a beep and the telephone number calling on the screen, as opposed to sending the call straight to voicemail. Additionally, the user uses the menu to set default lines for different services, such as voice 324, SMS 325 and data 326. In this example, the user has selected the telephone number as the default for voice 324 by checking the box. This means that the mobile device automatically uses the selected default telephone number for any outgoing telephone call the user makes. If the user decides to dial using a different telephone number, the user must change the default telephone number. Alternatively, some embodiments have an option to temporarily change the number used for outgoing calls for the next telephone call. The default options for text messaging and data work similarly. After selecting preferences, the user hits the OK button 327 in order to save his changes. Alternatively, the user hits the cancel button 328 which reverts the settings back to the previously saved settings.

In certain other exemplary embodiments, a hard switch or a soft switch may be used to select between different telephone and/or contact or identification numbers. A hard switch may be a physical external slide or toggle that is manually switched between two or more positions, each position indicating a different number. Such external switch may be on a side of the mobile device, such as a manual volume control button or other similar button, as may be shown by the black buttons in FIG. 3 and others. A soft key may be a touch screen control or option on a home page of a personal data assistant. Other switching mechanisms are also possible and are within the scope of the present invention.

In further embodiments of the preferences menu, settings are integrated with the user's contact list. In these embodiments, the user may select default telephone numbers to use on a per-contact basis. For instance, any time the user wants to call his boss, he will inevitably want to use his business telephone number. The option is available so that whenever the user places a call to his boss, the mobile device ignores the overall default telephone number and instead uses the contact-specific telephone number.

A multi-number mobile device can work with an existing service provider network. FIG. 4 shows a multi-number telephone in communication with a conventional network system, according to an exemplary embodiment of the present invention. The network system comprises a landline 431 or outside cellular telephone, a public switched telephone network (PSTN) 432, a cellular tower 433, a multi-number telephone 400, a service database 435, and a billing database 434. Landline 431 is in communication with PSTN 432. This allows landline 431 to make and receive calls to mobile devices within the service provider network. Cellular tower 433 is also in communication with PSTN 432, allowing users of cellular telephones, such as multi-number telephone 400, to connect with PSTN 432. When a call is made to or from multi-number telephone 400, multi-number telephone 400 is in communication with billing database 434 and service database 435 through cellular tower 433. Billing database 434 records the usage by each of the telephone numbers associated with multi-number telephone 400. The usage is stored along with the user's information and service type. Service database 435 determines the services available to each of the accounts for multi-number telephone 400 and either allows or denies multi-number telephone 400 access to those services. Service database 435 stores the available services for each account, including such services as voice, data, and SMS. For example, user may be attempting to surf the internet but is attempting to do so on an account that does not allow data transfer. Services database 435 receives the request and looks for data capability attached to that account. If services database 435 does not find data capability attached to that account, it will deny the service request. A user with a mobile device on the same service provider network as a user of a multi-number mobile device is capable of placing calls to the multi-number mobile device. This user uses the same network system when placing a call, but does not need to utilize PSTN 432, as the destination multi-number mobile device is within the same network system as the source mobile device.

Outgoing calls are made from the device with a pre-programmed preferences system. The preferences are straightforward. Each call can be made from one telephone number. When receiving calls the multi-number device simply uses the telephone number that was dialed for that telephone call. However, simultaneous incoming telephone calls to a multi-number mobile device are a little more difficult to handle, especially when the incoming calls are placed to different telephone numbers on the multi-number mobile device.

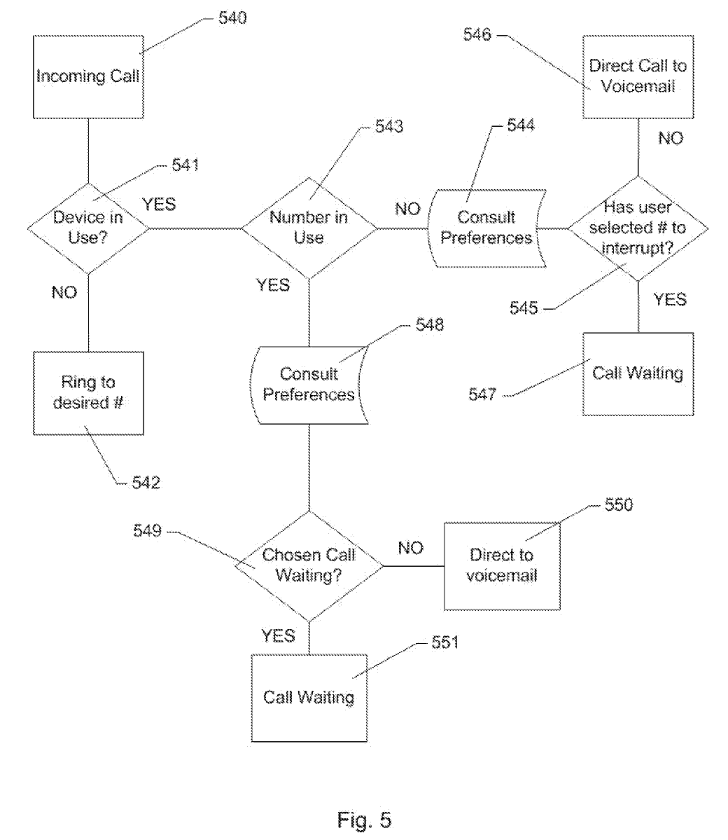

FIG. 5 shows a flowchart of a multi-number device beginning with an incoming call 540, according to an exemplary embodiment of the present invention. In this embodiment, the multi-number mobile device has two telephone numbers, two accounts, and thus two hardware IDs associated with. However, more than two are also possible and are within the scope of the present invention. Additionally, a user has programmed call interruption preferences. The flowchart shows a call incoming to multi-number mobile device 540. First, the multi-number mobile device determines whether or not it is currently in use 541. If the multi-number mobile device is not in use, the incoming call rings to the multi-number mobile device, displaying the dialed number on the caller ID screen 542. If the multi-number mobile device is in use, it determines whether the dialed telephone number is in use, or whether another telephone number is in use 543. If the dialed telephone number is not in use, the telephone determines that another telephone number on the multi-number mobile device is in use and consults the user's preferences 544 to determine the next step. The multi-number mobile device then determines whether the user has selected to interrupt the telephone number in use 545. If the user has selected and programmed the multi-number mobile device to interrupt the number currently in use, the call waiting function is used 547, and the user is alerted to the incoming call. If the user has selected not to be interrupted, the incoming call is directed to the user's voicemail 546. For instance, the user may be on his personal telephone number when a call is incoming from his business telephone number. The user has pre-selected calls from the business telephone number always to be sent to call waiting when his personal telephone number is in use. Thus the call activates call waiting and the user is notified and can switch to that call. When the user is on his business line, he may have selected not to be interrupted by any personal calls. In this instance, a personal call would be directed straight to the user's voicemail if the user is currently using his business telephone number. However, another telephone call placed to his business telephone number may activate call waiting. Alternatively, if the user has selected to not be interrupted during any business calls, the incoming call to the business telephone number while the user is on that telephone number will be routed directly to the user's voicemail. If the device is in use and the number dialed is in use as well, the device consults a preferences database 548 to determine the appropriate action. Pre-selected call interruption preferences 549 determines whether the incoming call is sent to call waiting 551 or directly to voicemail 550. The example shown and described in FIG. 5 has been presented in the case of two calls but is also applicable in the case of a call or a text message, or data transfer, or any combination of two or more of the incoming communication signals.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A multi-number mobile device comprising:
a housing;
a memory within the housing;
a processor within the housing;
an identifier within the housing;
a plurality of hardware IDs within the identifier; and
a wireless transmitter coupled to the housing,
wherein the identifier switches among the plurality of hardware IDs without the need for multiple identifiers.

2. The multi-number mobile device in claim 1, wherein the memory contains an operating system.

3. The multi-number mobile device in claim 2, wherein the operating system contains a program to set a plurality of user preferences.

4. The multi-number mobile device in claim 1, wherein the memory further contains a plurality of user preferences.

5. The multi-number mobile device in claim 4, wherein the user preferences include at least one of call interruption preferences, default telephone number preferences, and contact-specific preferences.

6. The multi-number mobile device in claim 1, wherein the identifier is a SIM card.

7. The multi-number mobile device in claim 6, wherein the plurality of hardware IDs is a plurality of service-subscriber keys.

8. The multi-number mobile device in claim 1, wherein the identifier has an identification memory and an identification processor.

9. The multi-number mobile device in claim 8, wherein the identification memory contains at least one of a user name, account information, and contact information.

10. An identifier on a multi-number mobile device comprising:
a memory;
a processor in communication with the memory; and
a plurality of hardware IDs within the memory;
wherein the processor switches among the plurality of hardware IDs in the memory.

11. The identifier in claim 10, further comprising an operating system.

12. The identifier in claim 11, wherein the operating system contains a program to set a plurality of user preferences.

13. The identifier in claim 12, wherein the memory is removable from a multi-number mobile device.

14. The identifier in claim 13, wherein the removable memory is fixed to a SIM card.

15. The identifier in claim 13, wherein the plurality of user preferences includes at least one of call interruption preferences, default telephone number preferences, and contact-specific preferences.

16. The identifier in claim 10, wherein the memory contains at least one of a user name, account information, and contact information.

17. A method of connecting a mobile device through a cellular connection comprising:
providing a mobile device possessing multiple hardware IDs and capable of utilizing each one separately while allowing a network to identify the mobile device by any of them; and
connecting the mobile device through the network;
wherein the mobile device registers each hardware ID with the network independently and simultaneously.

18. The method in claim 17, wherein the connecting comprises a user initiated connection to a destination.

19. The method in claim 18, wherein the connection is one of a voice call, text message, and data session.

20. The method in claim 17, wherein the connecting comprises receiving a connection initiated by another communications device.
